(19) United States
(12) Patent Application Publication
(10) Pub. No.: US 2023/0177666 A1
(43) Pub. Date: Jun. 8, 2023

(54) DEGRADATION DETECTION DEVICE, DEGRADATION DETECTION SYSTEM, DEGRADATION DETECTION METHOD, AND PROGRAM

(71) Applicant: NIPPON TELEGRAPH AND TELEPHONE CORPORATION, Tokyo (JP)

(72) Inventors: Yujin HAMANO, Tokyo (JP); Daisuke UCHIBORI, Tokyo (JP); Kazuaki WATANABE, Tokyo (JP); Masafumi NAKAGAWA, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 17/911,998

(22) PCT Filed: Mar. 18, 2020
(86) PCT No.: PCT/JP2020/012104

§ 371 Date: Sep. 15, 2022

(51) Int. Cl. G06T 7/00; G06T 7/11

(52) U.S. Cl. CPC G06T 7/0002; G06T 7/11; G06T 2207/30108; G06T 2207/20084; G06T 2207/20081; G06T 2207/30184; G06T 2207/20021

(57) ABSTRACT

A deterioration detection apparatus (200) that detects deterioration of equipment (3) attached to a structure (2), and includes an equipment region extraction unit (221) that extracts a region in which the equipment (3) is present, based on a captured image of the equipment (3), and a deterioration region detection unit (222) that detects a deterioration region of the equipment, based on the region in which the equipment (3) is present.

### TECHNICAL FIELD

The present disclosure relates to a deterioration detection apparatus, a deterioration detection system, a deterioration detection method, and a program.

### BACKGROUND ART

Infrastructure equipment, such as conduits, is attached to the lateral sides or back sides of structures such as bridges installed outdoors, in order to allow liquid, gas, communication cables, and the like to pass. Companies or local governments that own infrastructure equipment periodically inspect conduits or attachment members for attaching the conduits to bridges, and check for deterioration such as rusting.

Conventionally, inspection has been performed through close visual examination, in which a scaffold for inspection and the like are installed on the above-mentioned structures, and a worker approaches the equipment and inspects the equipment. However, there has been concern that inspection through close visual examination requires cost pertaining to installation of a scaffold, it is difficult to secure the safety of a worker in the case of high-place work, and the like. In view of this, in recent years, inspection methods have been proposed in which an unmanned drone captures an image of equipment, and deterioration of the equipment is efficiently detected based on the captured image using an image processing technology. NPL 1 discloses a technique for dividing a captured image into rectangular regions using an image classification technique that uses deep learning (CNN: Convolution Neural Network), and automatically determining whether or not there is deterioration in each of the divided rectangular regions, for example.

### CITATION LIST

### Non Patent Literature

[NPL 1] [Non-patent Document 1] Yu Tabata, and five others, “Study on automatic detection of bridge damage using UAV shooting and deep learning”, Construction Management Committee, F4, Vol. 74, No. 2, I_62-I_74, year 2018

### SUMMARY OF THE INVENTION

### Technical Problem

However, an image of equipment captured by an unmanned drone includes elements other than the equipment that is the inspection target, such as a tree, a river, a vehicle, a pedestrian, a sign, roads, and a building. Therefore, there has been a problem in that, with conventional techniques, it is difficult to accurately detect deterioration with focus on the target equipment based on such a captured image.

An object of the present disclosure that has been made with the foregoing in view is to provide a deterioration detection apparatus, a deterioration detection system, a deterioration detection method, and a program for enabling deterioration of equipment to be accurately detected based on a captured image.

### Means for Solving the Problem

A deterioration detection apparatus according to an embodiment of the present invention is a deterioration detection apparatus that detects deterioration of equipment attached to a structure, and includes an equipment region extraction unit configured to extract a region in which the equipment is present, based on a captured image of the equipment, and a deterioration region detection unit configured to detect a deterioration region of the equipment based on the region in which the equipment is present.

A deterioration detection system according to an embodiment of the present invention is a deterioration detection system that detects deterioration of equipment attached to a structure, and includes the above deterioration detection apparatus, an image capturing apparatus configured to capture an image of the equipment, and a server apparatus configured to store the deterioration region.

A deterioration detection method according to an embodiment of the present invention is a deterioration detection method for detecting deterioration of equipment attached to a structure, and includes a step of capturing an image of the equipment, a step of extracting a region in which the equipment is present, based on the captured image, and detecting a deterioration region of the equipment based on the region in which the equipment is present, and a step of storing the deterioration region.

A program according to an embodiment of the present invention causes a computer to function as the deterioration detection apparatus.

### Effects of the Invention

According to the present disclosure, it is possible to provide a deterioration detection apparatus, a deterioration detection system, a deterioration detection method, and a program for enabling deterioration of equipment to be accurately detected based on a captured image.

### BRIEF DESCRIPTION OF DRAWINGS

FIG. 1 is a diagram showing an exemplary configuration of a deterioration detection system according to an embodiment of the present invention.

FIG. 2 is a block diagram showing an exemplary configuration of a deterioration detection apparatus according to an embodiment of the present invention.

FIG. 3 is a diagram for describing an exemplary processing of a rectangular region division unit according to an embodiment of the present invention.

FIG. 4A is a diagram for describing exemplary processing of a rectangular region displacement unit according to an embodiment of the present invention.

FIG. 4B is a diagram for describing exemplary processing of a rectangular region displacement unit according to an embodiment of the present invention.

FIG. 5A is a diagram for describing exemplary processing of a score calculation unit according to an embodiment of the present invention.

FIG. 5B is a diagram for describing exemplary processing of a score calculation unit according to an embodiment of the present invention.

FIG. 5C is a diagram for describing exemplary processing of a score calculation unit according to an embodiment of the present invention.

FIG. 6 is a flowchart showing an example of a deterioration detection method according to an embodiment of the present invention.

FIG. 7 is a diagram showing an example of determination accuracies according to a working example and a comparative example.

FIG. 8A is a diagram showing an example of detection accuracy according to a working example.

FIG. 8B is a diagram showing an example of detection accuracy according to a comparative example.

### DESCRIPTION OF EMBODIMENTS

Embodiments of the present invention will be described below in detail with reference to the drawings.

### Configuration of Deterioration Detection System

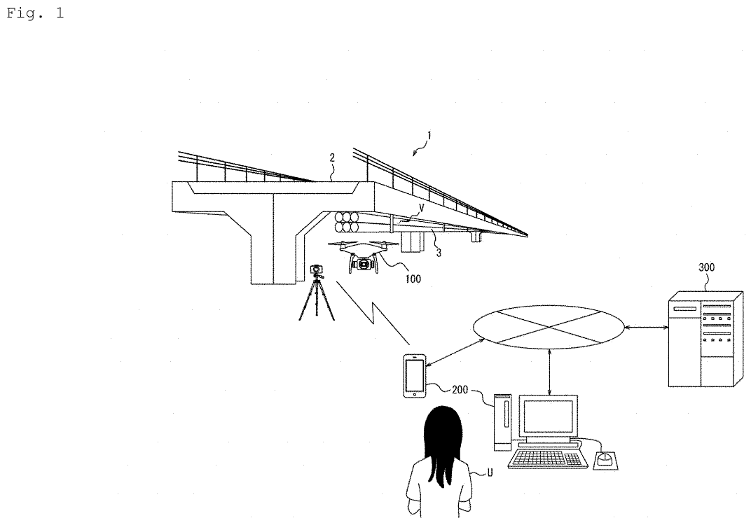

An exemplary configuration of a deterioration detection system 1 according to an embodiment of the present invention will be described with reference to FIG. 1.

The deterioration detection system 1 is a system that detects deterioration V of equipment 3 attached to a structure 2 based on a captured image (moving image, still image) of the equipment 3, using deep learning. Examples of the structure 2 include bridges. Examples of the equipment 3 include conduits, attachment members for attaching conduits to a bridge, and the like.

As shown in FIG. 1, the deterioration detection system 1 includes an image capturing apparatus 100, a deterioration detection apparatus 200, and a server apparatus 300. The image capturing apparatus 100, the deterioration detection apparatus 200, and the server apparatus 300 are connected to enable wired or wireless communication with each other. There is no particular limitation on a communication method for transmitting/receiving of information between the apparatuses.

The image capturing apparatus 100 is an uninhabited airborne vehicle, a telephoto camera, or the like. The image capturing apparatus 100 captures images of the equipment 3. It is sufficient for the image capturing apparatus 100 to have a function of optically capturing an image of the equipment 3, and there is no particular limitation on the configuration thereof. The image capturing apparatus 100 transmits image data of a captured image to the deterioration detection apparatus 200. Note that the captured image includes not only the equipment 3 but also elements other than the equipment 3 that is an inspection target, such as a tree, a river, a vehicle, a pedestrian, a sign, road, and a building.

Examples of the deterioration detection apparatus 200 include a mobile phone such as a smartphone, a tablet terminal, and a notebook PC (personal computer), which is used by a worker U. The deterioration detection apparatus 200 receives image data of a captured image from the image capturing apparatus 100. The deterioration detection apparatus 200 extracts a region in which the equipment 3 is present based on the captured image, and detects a deterioration region of the equipment 3 based on the region in which the equipment 3 is present, which will be described later in detail. The deterioration detection apparatus 200 transmits detection data of the deterioration region of the equipment 3 to the server apparatus 300 via a network.

The server apparatus 300 receives the detection data of the deterioration region of the equipment 3 from the deterioration detection apparatus 200 via the network. The server apparatus 300 stores the detection data of the deterioration region of the equipment 3.

### Deterioration Detection Apparatus

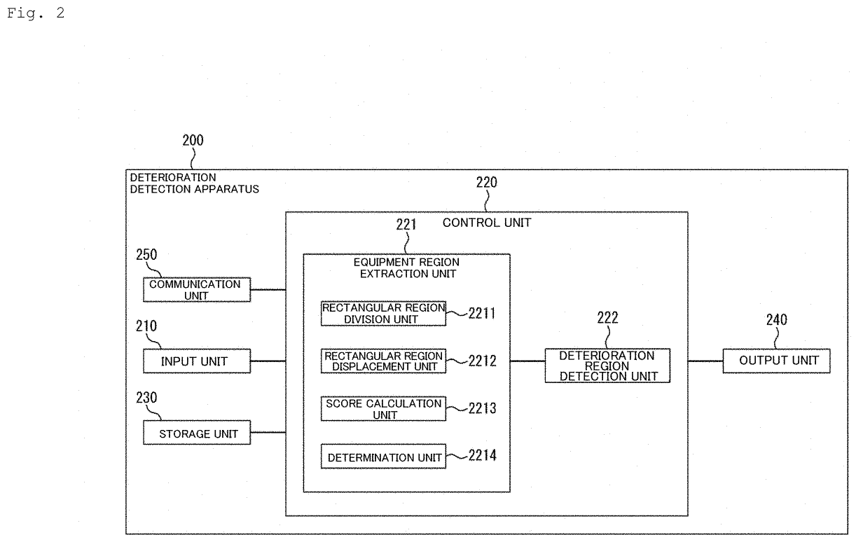

An exemplary configuration of the deterioration detection apparatus 200 according to the present embodiment will be described with reference to FIGS. 2 to 5C.

As shown in FIG. 2, the deterioration detection apparatus 200 includes an input unit 210, a control unit 220, a storage unit 230, an output unit 240, and a communication unit 250. The control unit 220 includes an equipment region extraction unit 221 and a deterioration region detection unit 222. The equipment region extraction unit 221 includes a rectangular region division unit 2211, a rectangular region displacement unit 2212, a score calculation unit 2213, and a determination unit 2214.

Various types of information are input to the input unit 210. The input unit 210 may be any device that enables the worker U to perform a predetermined operation, and may be a microphone, a touch panel, a keyboard, a mouse, or the like. As a result of the worker U performing a predetermined operation using the input unit 210 for example, image data of a captured image of the equipment 3 captured by the image capturing apparatus 100 is input to the equipment region extraction unit 221. The input unit 210 may be formed in one piece with the deterioration detection apparatus 200, or may also be provided separately.

The control unit 220 may be constituted by dedicated hardware, or may also be constituted by a general-purpose processor or a processor specialized for specific processing.

The equipment region extraction unit 221 extracts a region in which the equipment 3 is present, based on image data of the captured image input through the input unit 210, using an image classification technique that uses a CNN that represents a deep learning technique. Examples of a model include VGG16 and the like, but there is no limitation thereto. The equipment region extraction unit 221 outputs extraction data of the region in which the equipment 3 is present, to the deterioration region detection unit 222.

The following document can be referred to for details of VGG16, for example.

Karen Simonyan, Andrew Zisserman (2014), Very Deep Convolutional Networks for Large-Scale Image Recognition, arXiv:1409.1556 [cs. CV].

The equipment region extraction unit 221 will be described in detail.

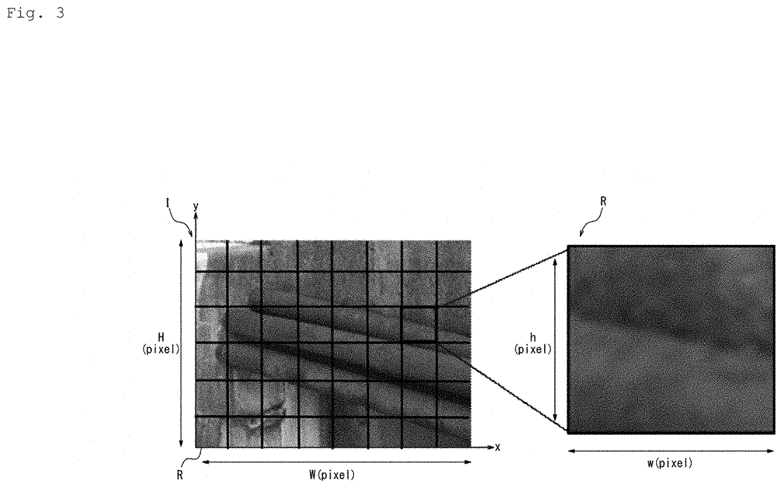

As shown in FIG. 3, for example, the rectangular region division unit 2211 divides a captured image I into a plurality of rectangular regions R. The size of the captured image I can be expressed as height: H (pixels) and width: W (pixels), for example. The size of each of the rectangular regions R can be expressed as height: h (pixels) and width: w (pixel), for example.

Specifically, the rectangular region division unit 2211 divides the captured image I into A×B (=(W/w)×(H/h)) rectangular regions R by separating rectangular regions R in the captured image I while moving in an X direction A (=W/w: constant) times and in a Y direction B (=H/h: constant) times. The rectangular region division unit 2211 divides the captured image I into 48 (=8×6) rectangular regions R, for example, by separating rectangular regions R in the captured image I while moving in the X direction eight times and in the Y direction six times. Note that the size of each rectangular region R (height: h, width: w), the number of rectangular regions R (A×B), and the like may be suitably set.

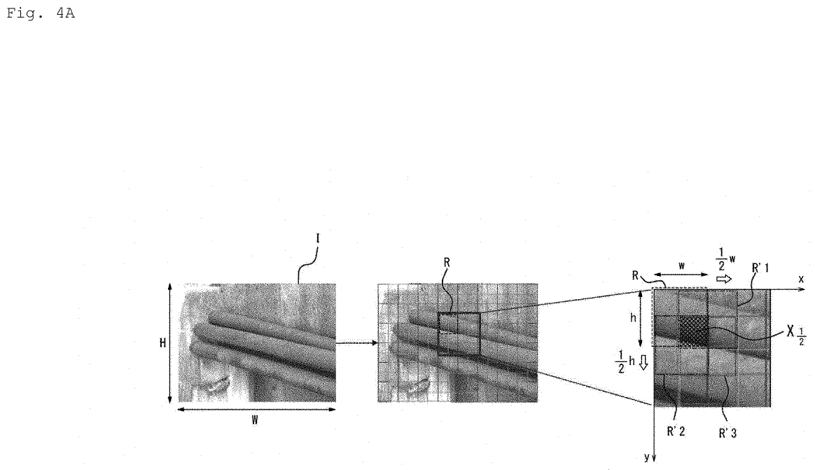

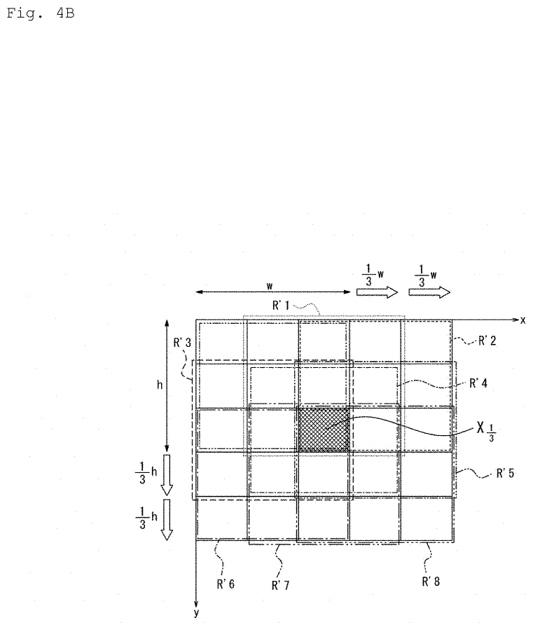

As shown in FIGS. 4A and 4B, for example, for each of the plurality of rectangular regions R included in the captured image I, the rectangular region displacement unit 2212 displaces the rectangular region R in x and y (two dimensional) directions such that a portion thereof overlaps, and generates a displaced rectangular region R′ corresponding to the rectangular region R. Accordingly, an overlapping region X in which the rectangular region R and the displaced rectangular region R′ overlap is generated. The number of displaced rectangular regions R′ may be one or larger. The larger the number of displaced rectangular regions R′ is, the larger the calculation load on the score calculation unit 2213 to be described later will be, but, by the rectangular region displacement unit 2212 generating appropriate number of displaced rectangular regions R′ at appropriate positions, it is possible to increase the calculation accuracy of the score calculation unit 2213, the determination accuracy of the determination unit 2214, the detection accuracy of the deterioration region detection unit 222, and the like.

Hereinafter, in the present specification, “1/2 displacement” means displacing the rectangular region R by w/2 in the X direction a predetermined number of times, or displacing the rectangular region R by h/2 in the Y direction a predetermined number of times (see open arrows in FIG. 4A). In addition, “1/3 displacement” means displacing the rectangular region R by w/3 in the X direction a predetermined number of times, or displacing the rectangular region R by h/3 in the Y direction a predetermined number of times (see open arrows in FIG. 4B). In addition, “1/n (n is an integer of two or larger) displacement” means displacing the rectangular region R by w/n in the X direction a predetermined number of times, or displacing the rectangular region R by h/n in the Y direction a predetermined number of times.

As shown in FIG. 4A, for example, the rectangular region displacement unit 2212 displaces the rectangular region R by w/2 in the X direction once and generates a displaced rectangular region R′1_{(1/2)}. In addition, the rectangular region displacement unit 2212 displaces the rectangular region R by h/2 in the Y direction once, and generates a displaced rectangular region R′2_{(1/2)}. In addition, the rectangular region displacement unit 2212 displaces the rectangular region R by w/2 in the X direction once and by h/2 in the Y direction once, and generates a displaced rectangular region R′3_{(1/2)}.

At this time, an overlapping region X_{(1/2)} in which the rectangular region R, the displaced rectangular region R′1_{(1/2)}, the displaced rectangular region R′2_{(1/2)}, and the rectangular region R′3_{(1/2)} overlap is generated. The size of the overlapping region X_{(1/2)} can be expressed as height: h/2 (pixels) and width: w/2 (pixels), for example.

As shown in FIG. 4B, for example, the rectangular region displacement unit 2212 displaces the rectangular region R by w/3 in the X direction once, and generates a displaced rectangular region R′1_{(1/3)}. In addition, the rectangular region displacement unit 2212 displaces the rectangular region R by w/3 in the X direction twice, and generates a displaced rectangular region R′2_{(1/3)}. In addition, the rectangular region displacement unit 2212 displaces the rectangular region R by h/3 in the Y direction once, and generates a displaced rectangular region R′3_{(1/3)}. In addition, the rectangular region displacement unit 2212 displaces the rectangular region R by w/3 in the X direction once and by h/3 in the Y direction once, and generates a displaced rectangular region R′4_{(1/3)}. In addition, the rectangular region displacement unit 2212 displaces the rectangular region R by w/3 in the X direction twice and by h/3 in the Y direction once, and generates a displaced rectangular region R′5_{(1/3)}. In addition, the rectangular region displacement unit 2212 displaces the rectangular region R by h/3 in the Y direction twice, and generates a displaced rectangular region R′6_{(1/3)}. In addition, the rectangular region displacement unit 2212 displaces the rectangular region R by w/3 in the X direction once and by h/3 in the Y direction twice, and generates a displaced rectangular region R′7_{(1/3)}. In addition, the rectangular region displacement unit 2212 displaces the rectangular region R by w/3 in the X direction twice and by w/3 in the Y direction twice, and generates a displaced rectangular region R′8_{(1/3)}.

At this time, an overlapping region X_{(1/3)} in which the rectangular region R, the displaced rectangular region R′1_{(1/3)}, the displaced rectangular region R′2_{(1/3)}, the displaced rectangular region R′3_{(1/3)}, the displaced rectangular region R′4_{(1/3)}, the displaced rectangular region R′5_{(1/3)}, the displaced rectangular region R′6_{(1/3)}, the displaced rectangular region R′7_{(1/3)}, and a displaced rectangular region R′8_{(1/3)} overlap is generated. The size of the overlapping region X_{(1/3)} can be expressed as height: h/3 (pixels) and width: w/3 (pixels), for example.

In addition, when generating displaced rectangular regions R′, the rectangular region displacement unit 2212 determines the number of displaced rectangular regions R′ and the positions of the displaced rectangular regions R′, in other words determines two-dimensional orthogonal coordinates P(x, y) on the xy plane.

When the coordinates of the rectangular region R are indicated by P(i, j), the coordinates of the displaced rectangular region R′ generated by displacing the rectangular region R by w/n in the X direction k times can be expressed as P_{(1/n)} (i+k, j). In addition, in this case, the coordinates of the displaced rectangular region R′ generated by displacing the rectangular region R by h/n in the Y direction once can be expressed as P_{(1/n)} (i, j+l). In addition, in this case, the coordinates of the displaced rectangular region R′ generated by displacing the rectangular region R by w/n in the X direction k times and by h/n in the Y direction once can be expressed as P_{(1/n)} (i+k, j+l).

As shown in FIG. 4A, for example, in the case of 1/2 displacement, the rectangular region displacement unit 2212 determines the number of displaced rectangular regions R′ as three, for example. In addition, the rectangular region displacement unit 2212 determines the coordinates of the first displaced rectangular region R′1_{(1/2)} as P_{(1/2)} (i+1, j), the coordinates of the second displaced rectangular region R′2_{(1/2)} as P_{(1/2)} (i, j+1), and the coordinates of the third displaced rectangular region R′3_{(1/2)} as P_{(1/2)} (i+1, j+1).

As shown in FIG. 4B, for example, in the case of 1/3 displacement, the rectangular region displacement unit 2212 determines the number of displaced rectangular region R′ as eight, for example. In addition, the rectangular region displacement unit 2212 determines the coordinates of the first displaced rectangular region R′1_{(1/3)} as P_{(1/3)}(i+1, j), the coordinates of the second displaced rectangular region R′2_{(1/3)} as P_{(1/3)} (i+2, j), the coordinates of the third displaced rectangular region R′3_{(1/3)} as P_{(1/3)}(i, j+1), the coordinates of the fourth displaced rectangular region R′4_{(1/3)} as P_{(1/3)}(i+1, j+1), the coordinates of the fifth displaced rectangular region R′5_{(1/3)} as P_{(1/3)}(i+2, j+1), the coordinates of the sixth displaced rectangular region R′6_{(1/3)} as P_{(1/3)}(i, j+2), the coordinates of the seventh displaced rectangular region R′7_{(1/3)} as P_{(1/3)}(i+1, j+2), and the coordinates of the eighth displaced rectangular region R′8_{(1/3)} as P_{(1/3)}(i+2, j+2).

The score calculation unit 2213 calculates a score S1 (first score) indicating whether or not the equipment 3 is present in the rectangular region R and a score S2 (second score) indicating whether or not the equipment 3 is present in the displaced rectangular region R′, using an image classification technique that uses a CNN that represents a deep learning technique. VGG16 is used for a model for performing learning, for example. The score S1 in the rectangular region R and the score S2 in the displaced rectangular region R′ are numerical values of 0 to 1, and are calculated as estimated values.

The score calculation unit 2213 then calculates a score S3 (third score) indicating whether or not the equipment 3 is present in the overlapping region X, based on the score S1 in the rectangular region R and the score S2 in the displaced rectangular region R′. The number of scores S2 in the displaced rectangular regions R′ matches the number of displaced rectangular regions R′. When three displaced rectangular regions R′ are generated by the rectangular region displacement unit 2212 for example, the score calculation unit 2213 calculates the score S3 in the overlapping region X based on four scores in total, namely the score S1 in the rectangular region R and three scores S2 in the three displaced rectangular regions R′. When eight displaced rectangular regions R′ are generated by the rectangular region displacement unit 2212 for example, the score calculation unit 2213 calculates the score S3 in the overlapping region X based on nine scores in total, namely the score S1 in the rectangular region R and eight scores S2 in the eight displaced rectangular regions R′.

The score calculation unit 2213 may calculate the weight average of the score S1 and the score S2, and use the weight average as score S3, for example. The score calculation unit 2213 may calculate the geometric average of the score S1 and the score S2, and may use the geometric average as score S3, for example. The score calculation unit 2213 may find the minimum values or maximum values of the score S1 and the score S2, and calculate the finding result as score S3, for example. Note that a method for calculating the score S3 is not limited to these calculation methods.

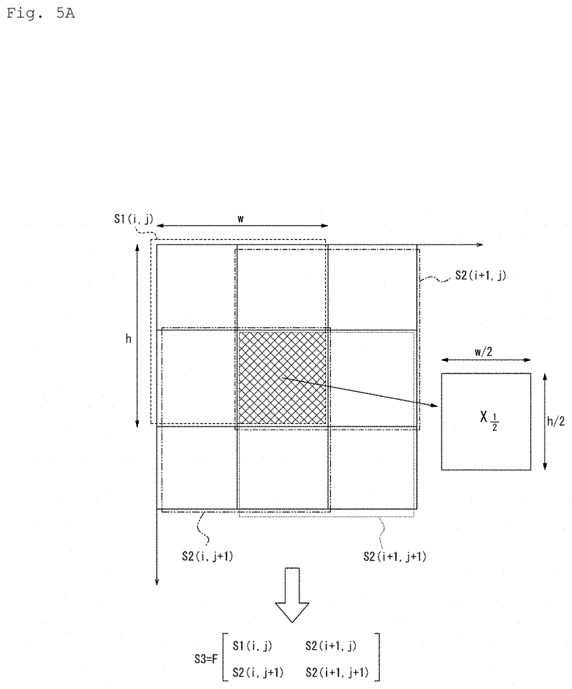

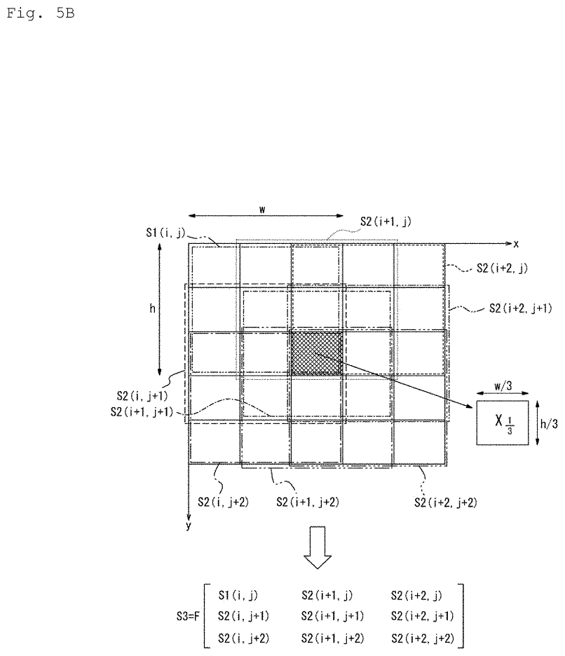

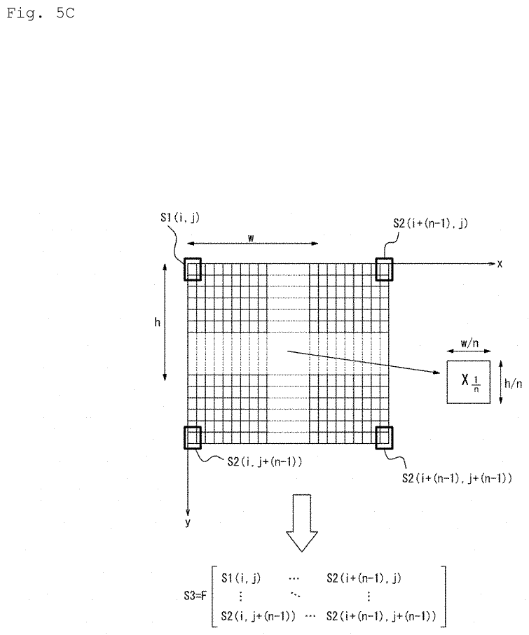

As shown in FIG. 5A, for example, in the case of 1/2 displacement, the score calculation unit 2213 calculates a score S1_{(1/2)} (i, j) in a rectangular region R_{(1/2)}. In addition, the score calculation unit 2213 calculates a score S2_{(1/2)} (i+1, j) in the displaced rectangular region R′1_{(1/2)}. In addition, the score calculation unit 2213 calculates a score S2_{(1/2)} (i, j+1) in the displaced rectangular region R′2_{(1/2)}. In addition, the score calculation unit 2213 calculates a score S2_{(1/2)} (i+1, j+1) in the displaced rectangular region R′3_{(1/2)}. Here, the overlapping region X_{(1/2)} holds four scores of the rectangular region R_{(1/2)} and the three displaced rectangular regions R′ in the vicinity of the rectangular region R_{(1/2)}.

Furthermore, the score calculation unit 2213 calculates a score S3_{(1/2)} in the overlapping region X_{(1/2)} based on the score S1_{(1/2)} (i, j) in the rectangular region R_{(1/2)}, the score S2_{(1/2)} (i+1, j) in the displaced rectangular region R′1_{(1/2)}, the score S2_{(1/2)} (i, j+1) in the displaced rectangular region R′2_{(1/2)}, and the score S2_{(1/2)} (i+1, j+1) in the displaced rectangular region R′3_{(1/2)}, using the following expression.

$$\begin{matrix}[ Math . 1 ] & \\ S {3}_{\frac{1}{2}} = F [ \begin{matrix}S {1}_{\frac{1}{2}} ( i , j ) & S {2}_{\frac{1}{2}} ( i + 1 , j ) \\ S {2}_{\frac{1}{2}} ( i , j + 1 ) & S {2}_{\frac{1}{2}} ( i + 1 , j + 1 )\end{matrix} ] & ( 1 )\end{matrix}$$

F in Expression 1 indicates computation of a weight average, a geometric average, a minimum value, a maximum value, or the like.

If F indicates computation of a weight average for example, the score calculation unit 2213 calculates the score S3_{(1/2)} in the overlapping region X_{(1/2)} based on the score S1_{(1/2)} (i, j) in the rectangular region R_{(1/2)}, the score S2_{(1/2)} (i+1, j) in the displaced rectangular region R′1_{(1/2)}, the score S2_{(1/2)} (i, j+1) in the displaced rectangular region R′2_{(1/2)}, and the score S2_{(1/2)} (i+1, j+1) in the displaced rectangular region R′3_{(1/2)}, using Expression 2 below. Here, a, b, c, and d each indicate a weight.

$$\begin{matrix}[ Math . 2 ] & \\ S {3}_{\frac{1}{2}} = \frac{\begin{matrix}a \times S {1}_{\frac{1}{2}} ( i , j ) + b \times S {2}_{\frac{1}{2}} ( i + 1 , j ) + \\ c \times S {2}_{\frac{1}{2}} ( i , j + 1 ) + d \times S {2}_{\frac{1}{2}} ( i + 1 , j + 1 )\end{matrix}}{a + b + c + d} & ( 2 )\end{matrix}$$

Here, assuming the score S1_{(1/2)} (i, j) in the rectangular region R_{(1/2)}=0.8, the score S2_{(1/2)} (i+1, j) in the displaced rectangular region R′1_{(1/2)}=0.7, the score S2_{(1/2)} (i, j+1) in the displaced rectangular region R′2_{(1/2)}=0.8, and the score S2_{(1/2)} (i+1, j+1) in the displaced rectangular region R′3_{(1/2)}=0.7, then the score S3_{(1/2)} in the overlapping region X_{(1/2)} can be expressed by the following expression.

$$\begin{matrix}[ Math . 3 ] & \\ S {3}_{\frac{1}{2}} = \frac{a \times 0.8 + b \times 0.7 + c \times 0.8 + d \times 0.7}{a + b + c + d} & ( 3 )\end{matrix}$$

If F indicates computation of a geometric average for example, the score calculation unit 2213 calculates the score S3_{(1/2)} in the overlapping region X_{(1/2)} based on the score S1_{(1/2)}(i, j) in the rectangular region R_{(1/2)}, the score S2_{(1/2)} (i+1, j) in the displaced rectangular region R′1_{(1/2)}, the score S2_{(1/2)} (i, j+1) in the displaced rectangular region R′2_{(1/2)}, and the score S2_{(1/2)} (i+1, j+1) in the displaced rectangular region R′3_{(1/2)} using the following expression.

$$\begin{matrix}[ Math . 4 ] & \\ S {3}_{\frac{1}{2}} = \frac{S {1}_{\frac{1}{2}} ( i , j ) + S {2}_{\frac{1}{2}} ( i + 1 , j ) + S {2}_{\frac{1}{2}} ( i , j + 1 ) + S {2}_{\frac{1}{2}} ( i + 1 , j + 1 )}{4} & ( 4 )\end{matrix}$$

Here, assuming the score S1_{(1/2)} (i, j) in the rectangular region R_{(1/2)}=0.8, the score S2_{(1/2)} (i+1, j) in the displaced rectangular region R′1_{(1/2)}=0.7, the score S2_{(1/2)} (i, j+1) in the displaced rectangular region R′2_{(1/2)}=0.8, and the score S2_{(1/2)} (i+1, j+1) in the displaced rectangular region R′3_{(1/2)}=0.7, then the score S3_{(1/2)} in the overlapping region X_{(1/2)} can be expressed by the following expression.

$$\begin{matrix}[ Math . 5 ] & \\ S {3}_{\frac{1}{2}} = \frac{0.8 + 0.7 + 0.8 + 0.7}{4} = 0.75 & ( 5 )\end{matrix}$$

As shown in FIG. 5, for example, in the case of 1/3 displacement, the score calculation unit 2213 calculates a score S1_{(1/3)}(i, j) in a rectangular region R_{(1/3)}. In addition, the score calculation unit 2213 calculates a score S2_{(1/3)}(i+1, j) in a displaced rectangular region R′1_{(1/3)}. In addition, the score calculation unit 2213 calculates a score S2_{(1/3)}(i+2, j) in a displaced rectangular region R′2_{(1/3)}. In addition, the score calculation unit 2213 calculates a score S2_{(1/3)}(i, j+1) in a displaced rectangular region R′3_{(1/3)}. In addition, the score calculation unit 2213 calculates a score S2_{(1/3)}(i+1, j+1) in a displaced rectangular region R′4_{(1/3)}. In addition, the score calculation unit 2213 calculates a score S2_{(1/3)}(i+2, j+1) in a displaced rectangular region R′5_{(1/3)}. In addition, the score calculation unit 2213 calculates a score S2_{(1/3)}(i, j+2) in a displaced rectangular region R′6_{(1/3)}. In addition, the score calculation unit 2213 calculates a score S2_{(1/3)}(i+1, j+2) in a displaced rectangular region R′7_{(1/3)}. In addition, the score calculation unit 2213 calculates a score S2_{(1/3)}(i+2, j+2) in the displaced rectangular region R′8_{(1/3)}. Here, the overlapping region X_{(1/3)} holds nine scores in the rectangular region R_{(1/3)} and the eight displaced rectangular regions R′ in the vicinity of the rectangular region R_{(1/3)}.

Furthermore, the score calculation unit 2213 calculates a score S3_{(1/3)} in the overlapping region X_{(1/3)} based on the score S1_{(1/3)}(i, j) in the rectangular region R_{(1/3)}, the score S2_{(1/3)}(i+1, j) in the displaced rectangular region R′1_{(1/3)}, the score S2_{(1/3)}(i+2, j) in the displaced rectangular region R′2_{(1/3)}, the score S2_{(1/3)}(i, j+1) in the displaced rectangular region R′3_{(1/3)}, the score S2_{(1/3)}(i+1, j+1) in the displaced rectangular region R′4_{(1/3)}, the score S2_{(1/3)}(i+2, j+1) in the displaced rectangular region R′5_{(1/3)}, the score S2_{(1/3)}(i, j+2) in the displaced rectangular region R′6_{(1/3)}, the score S2_{(1/3)}(i+1, j+2) in the displaced rectangular region R′7_{(1/3)}, and the score S2_{(1/3)}(i+2, j+2) in the displaced rectangular region R′8_{(1/3)}, using the following expression.

$$\begin{matrix}[ Math . 6 ] & \\ S {3}_{\frac{1}{2}} = [ \begin{matrix}S {1}_{\frac{1}{3}} ( i , j ) & S {2}_{\frac{1}{3}} ( i + 1 , j ) & S {2}_{\frac{1}{3}} ( i + 2 , j ) \\ S {2}_{\frac{1}{3}} ( i , j + 1 ) & S {2}_{\frac{1}{3}} ( i + 1 , j + 1 ) & S {2}_{\frac{1}{3}} ( i + 2 , j + 1 ) \\ S {2}_{\frac{1}{3}} ( i , j + 2 ) & S {2}_{\frac{1}{3}} ( i + 1 , j + 2 ) & S {2}_{\frac{1}{3}} ( i + 2 , j + 2 )\end{matrix} ] & ( 6 )\end{matrix}$$

F in Math. 6 indicates computation of a weight average, a geometric average, a minimum value, a maximum value, or the like.

As shown in FIG. 5C, for example, also in the case of 1/n displacement, similarly to the cases of 1/2 displacement and 1/3 displacement, the score calculation unit 2213 calculates a score S1_{(1/n)} in a rectangular region R_{(1/n)} and scores S2_{(1/n)} in displaced rectangular regions R′_{(1/n)}. Furthermore, the score calculation unit 2213 calculates a score S3_{(1/n)} in an overlapping region X_{(1/n)} based on the score S1_{(1/n)} in the rectangular region R_{(1/n)} and the scores S2_{(1/n)} in the displaced rectangular regions R′_{(1/n)}.

Note that, when calculating the score S3 in the overlapping region X, the score calculation unit 2213 does not necessarily need to adopt all of the scores of the overlapping region X to perform the above computation. The score calculation unit 2213 may select a plurality of scores from all of the scores of the overlapping region X as appropriate to perform the above computation. At this time, for example, the score calculation unit 2213 may select a score in a displaced rectangular region R′ that is more proximal to the rectangular region R, and exclude a score in a displaced rectangular region R′ that is more distant from the rectangular region R.

The determination unit 2214 determines whether or not the equipment 3 is present in the rectangular region R, based on the score S3 in the overlapping region X. The determination unit 2214 compares score S3 in the overlapping region X with a threshold value Vth, and if the score S3 in the overlapping region X is larger than or equal to the threshold value Vth, the determination unit 2214 determines that the equipment 3 is present in the rectangular region R, and if the score S3 in the overlapping region X is smaller than the threshold value Vth, the determination unit 2214 determines that the equipment 3 is not present in the rectangular region R. The threshold value Vth is not particularly limited, and may be suitably set, or may also be mechanically calculated. The determination unit 2214 outputs extraction data of a region in which the equipment 3 is present, to the deterioration region detection unit 222.

If the score S3 in the overlapping region X is 0.8 and the threshold value Vth is 0.7 for example, the determination unit 2214 determines that the equipment 3 is present in the rectangular region R, in other words the image in the rectangular region R is an image of the equipment 3. Accordingly, this rectangular region R is extracted as a region in which the equipment 3 is present.

If the score S3 in the overlapping region X is 0.6 and the threshold value Vth is 0.7 for example, the determination unit 2214 determines that the equipment 3 is not present in the rectangular region R, in other words the image in the rectangular region R is not an image of the equipment (but an image of an element other than the equipment 3 that is an inspection target, such as a tree, a river, a vehicle, a pedestrian, a sign, a road, and a building).

The deterioration region detection unit 222 detects a deterioration region of the equipment 3 based on the extraction data of the region in which the equipment 3 is present, which has been input from the equipment region extraction unit 221, using a region detection technique that uses semantic segmentation that represents a deep learning technique. The deterioration region of the equipment 3 comes in all shapes, sizes, and the like, and thus recognition in units of pixels, instead of class-classification type recognition, is preferably performed. Examples of a semantic segmentation model include U-net and the like, but there is no limitation thereto. The deterioration region detection unit 222 outputs the extraction data of the deterioration region of the equipment 3 to the output unit 240.

The following document can be referred to for details of U-net, for example.
Olaf Ronneberger et. al (2015), Convolutional Networks for Biomedical Image Segmentation, arXiv:1505.04597 [cs. CV].

The storage unit 230 includes one or more memories, and may include a semiconductor memory, a magnetic memory, an optical memory, and the like. Each memory of the storage unit 230 may function as a primary storage device, a secondary storage device, or a cache memory, for example. Each memory does not necessarily need to be provided inside the deterioration detection apparatus 200, and a configuration may also be adopted in which each memory is provided outside the deterioration detection apparatus 200.

The storage unit 230 stores various types of information to be used for operations of the deterioration detection apparatus 200. The storage unit 230 stores image data of a captured image, extraction data of a region in which the equipment 3 is present, extraction data of a deterioration region of the equipment 3, and the like. The storage unit 230 also stores data such as the rectangular region R, the displaced rectangular regions R′, the overlapping region X, the score S1, the scores S2, and score S3. Besides, the storage unit 230 stores various programs, various types of data, and the like.

The output unit 240 outputs various types of information. The output unit 240 is a liquid crystal display, an organic EL (Electro-Luminescence) display, a speaker, or the like. The output unit 240 displays a predetermined screen based on detection data of a deterioration region of the equipment 3 input from the deterioration region detection unit 222, for example. The output unit 240 may be formed in one piece with the deterioration detection apparatus 200, or may also be provided separately.

The communication unit 250 has a function of communicating with the image capturing apparatus 100 and a function of communicating with the server apparatus 300. The communication unit 250 receives image data of a captured image from the image capturing apparatus 100, for example. The communication unit 250 transmits detection data of a deterioration region of the equipment 3 to the server apparatus 300, for example.

The deterioration detection apparatus 200 according to the present embodiment extracts a region in which equipment is present, based on a captured image, and detects a deterioration region of the equipment based on the region in which the equipment is present. When extracting the region in which the equipment is present, the deterioration detection apparatus 200 uses a plurality of scores calculated for one rectangular region generated by dividing the captured image, instead of one score calculated for the one rectangular region generated by dividing the captured image. Accordingly, even if a captured image shows elements other than the equipment, it is possible to accurately specify an image of the equipment from such a captured image, and thus it is possible to accurately detect deterioration of the equipment.

### Deterioration Detection Method

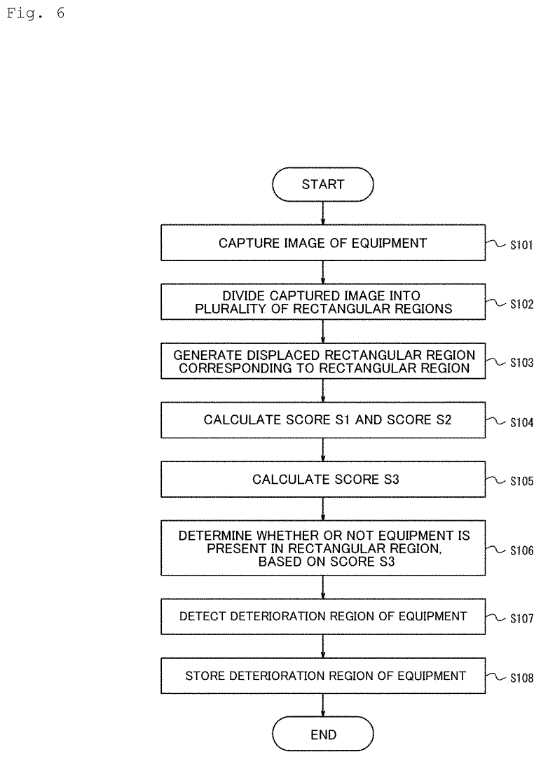

An example of a deterioration detection method according to an embodiment of the present invention will be described with reference to FIG. 6.

In step S101, the image capturing apparatus 100 captures an image of the equipment 3. The image capturing apparatus 100 transmits image data of the captured image to the deterioration detection apparatus 200. Note that the worker U may store the image data of the image captured by the image capturing apparatus 100, in an electron medium such as a memory card or a USB memory.

In step S102, the deterioration detection apparatus 200 receives the image data of the captured image from the image capturing apparatus 100. The deterioration detection apparatus 200 divides the captured image into a plurality of rectangular regions.

In step S103, for each of the plurality of rectangular regions included in the captured image, the deterioration detection apparatus 200 displaces the rectangular region in the x and y directions such that a portion thereof overlaps, and thereby generates a displaced rectangular region corresponding to the rectangular region.

In step S104, the deterioration detection apparatus 200 calculates a score S1 indicating whether or not the equipment 3 is present in each rectangular region and a score S2 indicating whether or not the equipment 3 is present in the displaced rectangular region, using an image classification technique that uses CNN that is a deep learning technique. VGG16 is used as a model, for example.

In step S105, the deterioration detection apparatus 200 calculates a score S3 indicating whether or not the equipment 3 is present in the overlapping region, based on the score S1 indicating whether or not the equipment 3 is present in the rectangular region and the score S2 indicating whether or not the equipment 3 is present in the displaced rectangular region, using a predetermined calculation method.

In step S106, the deterioration detection apparatus 200 determines whether or not the equipment 3 is present in the rectangular region, based on the score S3 indicating whether or not the equipment 3 is present in the overlapping region. The deterioration detection apparatus 200 compares the score S3 in the overlapping region with the threshold value Vth, and, if the score S3 in the overlapping region is larger than or equal to the threshold value Vth, the deterioration detection apparatus 200 determines that the equipment 3 is present in the rectangular region, and, if the score S3 in the overlapping region X is smaller than the threshold value Vth, the deterioration detection apparatus 200 determines that the equipment 3 is not present in the rectangular region.

In step S107, the deterioration detection apparatus 200 detects a deterioration region of the equipment 3 based on extraction data of the region in which the equipment 3 is present, using a region detection technique that uses semantic segmentation that represents a deep learning technique. U-net is used for the model, for example. The deterioration detection apparatus 200 transmits detection data of the deterioration region of the equipment 3 to the server apparatus 300.

In step S108, the server apparatus 300 receives the detection data of the deterioration region of the equipment 3 from the deterioration detection apparatus 200. The server apparatus 300 stores the detection data of the deterioration region of the equipment 3.

In the deterioration detection method according to the present embodiment, instead of one-stage processing in which a deterioration region of equipment is detected based on a captured image as is conventional, two-stage processing is performed in which a region in which equipment is present is extracted based on a captured image, and a deterioration region of the equipment is detected based on the region in which the equipment is present. Accordingly, even if a captured image shows an element other than the equipment, it is possible to accurately specify an image of the equipment based on such a captured image, and thus it is possible to accurately detect deterioration of the equipment that is an inspection target.

### Evaluation of Determination Accuracy

The determination accuracy of a score when the deterioration detection apparatus 200 according to the present embodiment (that includes an equipment region extraction unit) is used was compared with the determination accuracy of a score when a conventional deterioration detection apparatus (that does not include an equipment region extraction unit) is used, and evaluation was performed.

The determination accuracy of a score was calculated based on a confusion matrix. The true positive rate (TPR) is used as an index of evaluation of the determination accuracy of the score. Note that, besides the true positive rate, accuracy, precision, False Positive Rate (FPR), or the like may also be used as an index of evaluation of the determination accuracy of a score.

1/2 displacement was performed as a working example. The size of a rectangular region R_{(1/2)} was set to height: h=80 (pixels) and width: w=80 (pixels). The size of an overlapping region X_{(1/2)} was set to height: h=40 (pixels) and width: w=40 (pixels). The average value of a score S1 in the rectangular region R, a score S2 in a displaced rectangular region R′1_{(1/2)}, a score S2 in a displaced rectangular region R′2_{(1/2)}, and a score S2 in the displaced rectangular region R′3_{(1/2)} was calculated as a score S3 in an overlapping region X_{(1/2)}.

As a comparative example, a rectangular region R was not displaced. The size of the rectangular region R was set to height: h=40 (pixels) and width: w=40 (pixels). A score S in a predetermined region included in the rectangular region R was calculated. The size of the predetermined region was set to height: h=40 (pixels) and width: w=40 (pixels).

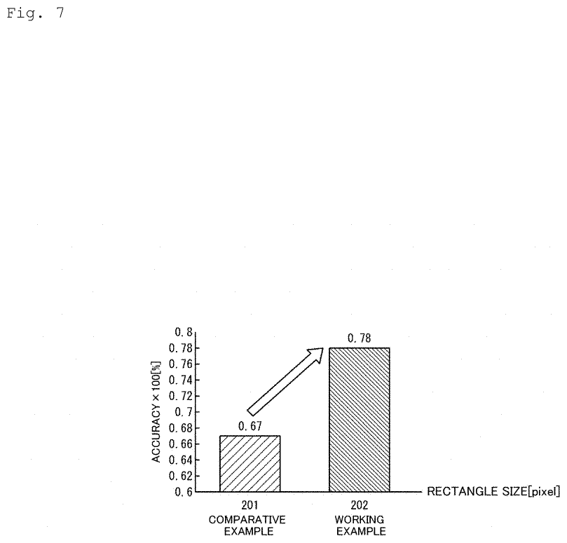

The graph 201 shown in FIG. 7 indicates that, in the comparative example, the true positive rate is 67%. The graph 202 shown in FIG. 7 indicates that, in the working example, the true positive rate is 78%. That is to say, the determination accuracy of a score according to the working example is higher than the determination accuracy of a score according to the comparative example by about 10%.

Therefore, it is indicated that the determination accuracy of a score according to the deterioration detection apparatus 200 according to the present embodiment is higher than that of the conventional deterioration detection apparatus. That is to say, it is indicated that the deterioration detection apparatus 200 according to the present embodiment can accurately specify an image of equipment based on a captured image.

Note that, in the above working example, when 1/2 displacement, 1/3 displacement, . . . , and 1/n displacement were performed, and determination accuracies of a score, computation amounts, and computation times were compared, the computation amount and computation time increased as n takes a larger value. It was found that, when the balance between these are taken into consideration, 1/2 displacement is the most suitable among 1/2 displacement, 1/3 displacement, . . . , and 1/n displacement. Therefore, it is indicated that, by the deterioration detection apparatus 200 generating an appropriate number of rectangular regions at appropriate positions, a high effect is achieved.

### Evaluation of Detection Accuracy

The detection accuracy of a deterioration region of the equipment 3 when the deterioration detection apparatus 200 according to the present embodiment (that includes an equipment region extraction unit) is used was compared with the detection accuracy of a deterioration region of equipment 3 when a conventional deterioration detection apparatus (that does not include an equipment region extraction unit) is used, and evaluation was performed.

As a working example, a region in which the equipment 3 is present was extracted based on a captured image I, and a deterioration region of the equipment 3 was detected based on a region 300 in which the equipment 3 is present.

As a comparative example, a deterioration region of the equipment 3 was detected based on a captured image I.

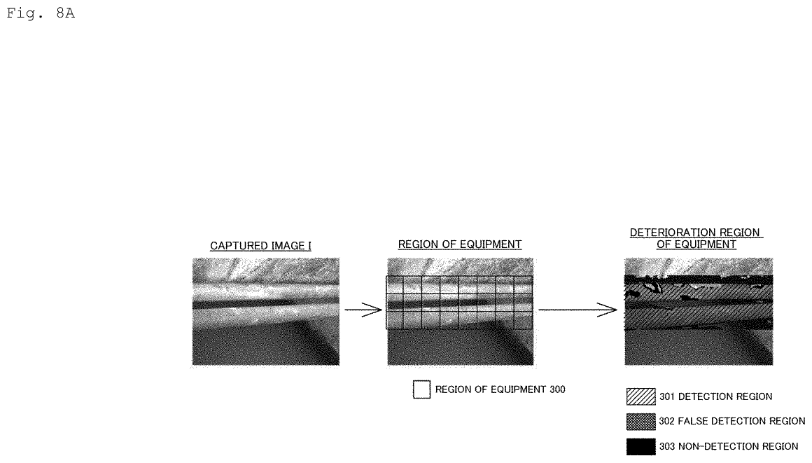

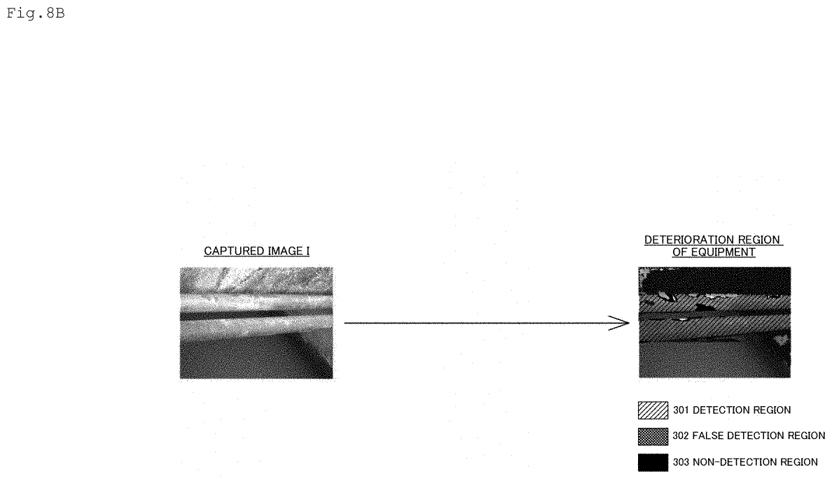

FIG. 8A is a diagram showing an example of detection accuracy according to the working example. The region 301 indicates a detection region. The region 302 indicates a false detection region. The region 303 indicates a non-detection region.

FIG. 8B is a diagram showing an example of detection accuracy according to the comparative example. The region 301 indicates a detection region. The region 302 indicates a false detection region. The region 303 indicates a non-detection region.

A comparison between the region 301 shown in FIG. 8A and the region 301 shown in FIG. 8B indicates that the region 301 shown in FIG. 8A is larger than the region 301 shown in FIG. 8B. In addition, a comparison between the region 302 shown in FIG. 8A and the region 302 shown in FIG. 8B indicates that the region 302 shown in FIG. 8A is smaller than the region 302 shown in FIG. 8B. That is to say, it indicates that a deterioration region of the equipment 3 is more accurately detected according to the working example than the comparative example.

A comparison between the region 303 shown in FIG. 8A and the region 303 shown in FIG. 8B indicates that the region 303 shown in FIG. 8A is smaller than the region 303 shown in FIG. 8B. That is to say, it indicates that false detection of a deterioration region of the equipment 3 is less likely according to the working example than the comparative example.

Therefore, it is indicated that, with the deterioration detection apparatus 200 according to the present embodiment, the detection accuracy of the deterioration region of the equipment 3 is higher than that of the conventional deterioration detection apparatus. That is to say, it is indicated that the deterioration detection apparatus 200 according to the present embodiment can accurately detect deterioration of the equipment 3 based on a captured image.

### Modified Example

The present invention is not limited to the above embodiments and modified examples. The above-described various types of processing may not only be executed chronologically as described, but may also be executed in parallel or individually as required or according to the processing capacity of the device that executes the processing, for example. Besides, modifications can be made as appropriate to the extent that they do not depart from the spirit of the invention.

### Program and Recording Medium

It is also possible to use a computer that can execute a program instruction in order to cause the computer to function as the above embodiments and modified examples. Such a computer can be realized by storing, in the storage unit of the computer, a program on which processing contents for realizing functions of devices are written, and causing the processor of the computer to read out and execute this program, and at least some of the processing contents may be realized with hardware. Here, the computer may be a general-purpose computer, a dedicated computer, a work station, a PC, an electronic notepad, or the like. The program instruction may be program codes, code segments, or the like for executing a necessary task. The processor may be a CPU (Central Processing Unit), a GPU (Graphics Processing Unit), a DSP (Digital Signal Processor), an ASIC (Application Specific Integrated Circuit), or the like.

A program for causing a computer to execute the above-described deterioration detection method is, referring to FIG. 6, a deterioration detection method for detecting deterioration of equipment attached to a structure, for example, and includes a step of capturing an image of the equipment (step S101), a step of extracting a region in which the equipment is present based on the captured image (steps S102 to S106), a step of detecting a deterioration region of the equipment based on the region in which the equipment is present (step S107), and a step of storing the deterioration region (step S108).

In addition, this program may be recorded in a computer-readable recording medium. Using such a recording medium, the program can be installed in a computer. Here, the recording medium on which the program is recorded may be a non-transient recording medium. The non-transient recording medium may be a CD (Compact Disk)-ROM (Read-Only Memory), DVD (Digital Versatile Disk)-ROM, BD (Blu-ray (registered trademark) Disk)-ROM, or the like. In addition, this program can be provided by being downloaded via a network.

Although the above embodiments have been described as a representative example, it is apparent to those of ordinary skill in the art that many modifications and replacements can be made to the extent that they do not depart from the scope and spirit of the present disclosure. Therefore, the present invention is not to be interpreted as limiting by the above embodiments, and various modifications and changes can be made without departing from the scope of the claims. A plurality of configuration blocks illustrated in a configuration diagram of an embodiment of the present invention can be combined into one, or one configuration block can be divided, for example. In addition, a plurality of processes illustrated in a flowchart of an embodiment of the present invention can be combined into one, or one process can be divided.

### REFERENCE SIGNS LIST

1 Deterioration detection system
2 Structure
3 Equipment
100 Image capturing apparatus
200 Deterioration detection apparatus
210 Input unit
220 Control unit
230 Storage unit
240 Output unit
250 Communication unit
221 Equipment region extraction unit
222 Deterioration region detection unit
300 Server apparatus
2211 Rectangular region division unit
2212 Rectangular region displacement unit
2213 Score calculation unit
2214 Determination unit

1. A deterioration detection apparatus for detecting deterioration of equipment attached to a structure, comprising a processor configured to execute a method comprising:
extracting a region in which the equipment is present, based on a captured image of the equipment; and
detecting a deterioration region of the equipment based on the region in which the equipment is present.

2. The deterioration detection apparatus according to claim 1,
wherein the extracting a region further comprises:
dividing the captured image into a plurality of rectangular regions,
displacing, for each of the rectangular regions, the rectangular region,
generating a displaced rectangular region corresponding to the rectangular region, and
the processor further configured to execute a method comprising:
calculating, for each of the rectangular regions, a third score indicating whether or not the equipment is present in an overlapping region in which the rectangular region and the displaced rectangular region overlap, based on a first score indicating whether the equipment is present in the rectangular region and a second score indicating whether the equipment is present in the displaced rectangular region; and
determining, for each of the rectangular regions, whether the equipment is present in the rectangular region based on the third score.

3. The deterioration detection apparatus according to claim 2,
wherein the displacing the rectangular region further comprises generating a plurality of displaced rectangular regions for each of the rectangular regions.

4. A deterioration detection system that detects deterioration of equipment attached to a structure, the system comprising a processor configured to execute a method comprising:
extracting a region in which the equipment is present, based on a captured image of the equipment;
detecting a deterioration region of the equipment based on the region in which the equipment is present;
capturing an image of the equipment; and
storing the deterioration region.

5. A deterioration detection method for detecting deterioration of equipment attached to a structure, the method comprising:
capturing an image of the equipment;
extracting a region in which the equipment is present, based on the captured image, and detecting a deterioration region of the equipment based on the region in which the equipment is present; and
storing the deterioration region.

6. The deterioration detection method according to claim 5,
wherein the detecting a deterioration region of the equipment further comprises:
dividing the captured image into a plurality of rectangular regions;
displacing, for each of the rectangular regions, the rectangular region;
generating a displaced rectangular region corresponding to the rectangular region;
calculating, for each of the rectangular regions, a third score indicating whether the equipment is present in an overlapping region in which the rectangular region and the displaced rectangular region overlap, based on a first score indicating whether the equipment is present in the rectangular region and a second score indicating whether the equipment is present in the displaced rectangular region; and
determining, for each of the rectangular regions, whether or not the equipment is present in the rectangular region based on the third score.

7. The deterioration detection method according to claim 6,
wherein the generating a displaced rectangular region further comprises generating a plurality of displaced rectangular regions for each of the rectangular regions.

8. (canceled)

9. The deterioration detection apparatus according to claim 1, wherein the extracting a region uses a convolution neural network based on a deep learning technique.

10. The deterioration detection system according to claim 4,
wherein the extracting a region further comprises:
dividing the captured image into a plurality of rectangular regions,
displacing, for each of the rectangular regions, the rectangular region,
generating a displaced rectangular region corresponding to the rectangular region, and
the processor further configured to execute a method comprising:
calculating, for each of the rectangular regions, a third score indicating whether or not the equipment is present in an overlapping region in which the rectangular region and the displaced rectangular region overlap, based on a first score indicating whether the equipment is present in the rectangular region and a second score indicating whether the equipment is present in the displaced rectangular region; and
determining, for each of the rectangular regions, whether the equipment is present in the rectangular region based on the third score.

11. The deterioration detection system according to claim 4, wherein the displacing the rectangular region further comprises generating a plurality of displaced rectangular regions for each of the rectangular regions.

12. The deterioration detection system according to claim 4, wherein the extracting a region uses a convolution neural network based on a deep learning technique.

13. The deterioration detection method according to claim 5, wherein the extracting a region uses a convolution neural network based on a deep learning technique.
